(19) United States
(12) Patent Application Publication
(10) Pub. No.: US 2009/0240647 A1
(43) Pub. Date: Sep. 24, 2009

(54) METHOD AND APPRATUS FOR DETECTING PATTERNS OF BEHAVIOR

(75) Inventors: Omar Green, San Francisco, CA (US); Desiree Gosby, San Franscisco, CA (US)

Correspondence Address: Saul Ewing LLP (Harrisburg);Attn: Patent Docket Clerk, Penn National Insurance Plaza, 2 North Second Street, Harrisburg, PA, 17101, US

(73) Assignee: AppleSeed Networks, Inc., New York, NY (US)

(21) Appl. No.: 12/407,515

(22) Filed: Mar. 19, 2009

Related U.S. Application Data
(60) Provisional application No. 61/037,897, filed on Mar. 19, 2008.

(51) Int. Cl. G06N 7/02

(52) U.S. Cl. 706/52

(57) ABSTRACT

Systems, apparatus, techniques, and methods are disclosed for predictively adapting properties of devices as a function of a user's historical behaviors (e.g., habits) as well as the specific context within which such behaviors are displayed. Such context can be virtually anything, such as day of the week, time of day, season, tide, temperature, weather, the user's mood, the score of a particular sporting event from the previous day, the phase of the moon, the user's location, etc. Based on observation by software, the user's habits and the context within which those habits occur are observed and the device is customized based on the user's behavioral patterns and the context thereof

### RELATED APPLICATIONS

This application claims priority to U.S. Provisional Application No. 61/037,897 filed Mar. 19, 2008, incorporated herein by reference fully and completely.

### FIELD OF TERMINOLOGY

The invention pertains to software and methods for behavioral data mining.

### BACKGROUND

Human beings are creatures of habit. Accordingly, many modern day electronic and other devices are designed to be adaptable or customizable by their owners to simplify the use of the device by being adaptable to accommodate those habits. For instance, many cellular telephones and home telephones permit a user to program speed dial numbers into them which allows the user to dial certain telephone numbers by pressing only one key or button, rather than having to dial the entire telephone number. Likewise, many computer programs allow the user to customize one or more of the graphical user interfaces to their personal preferences. For instance, in many programs, such as Microsoft Word, a user can customize toolbars in order to make those tools or features that are used commonly more readily accessible on the toolbars, while infrequently used tools and features are relegated to drop down menus or other less convenient means of access.

Some modern electronic devices even attempt to automatically predict user preferences and customize the user experience based on such predictions. For instance, certain digital video recording devices (DVRs) available today are adapted to monitor the programs selected for recording by their users and, based on a predictive algorithm using that information, predict other programs that the user of that DVR may be interested in. Thus, depending on the particular embodiment, it may automatically record such programs on that DVR and/or send a message to the DVR to notify the user of an upcoming broadcast of programs that the user may be interested in and asking the user if he wants to record it.

Another example of a somewhat similar experience can be found within various commercial websites. Particularly, if a user purchases a particular product via an e-commerce website (or even simply expresses an interest in a particular product by viewing it on the website), many websites will search their own database to determine correlations of that with other products and present those other products on the same web page for viewing by the consumer. In one particularly popular embodiment of this technique, a website may run a query of its databases to determine what other products have commonly been purchased by previous customers who have purchased the product now being viewed by the current user and then recommend to the current user that they may be interested in those other products.

### SUMMARY

A system, apparatus, and method is disclosed for predictively adapting properties of devices as a function of a user's historical behaviors (e.g., habits) as well as the specific context within which such behaviors are displayed. Such context can be virtually anything, such as day of the week, time of day, season, tide, temperature, weather, the user's mood, the score of a particular sporting event from the previous day, the phase of the moon, the user's location, etc. Based on observation by software, the user's habits and the context within which those habits occur are observed and the device is customized based on the user's behavioral patterns and the context thereof.

### BRIEF DESCRIPTION OF THE DRAWINGS

FIG. 1 is a block diagram of the various components of the system in one particular network-based embodiment.

FIG. 2 is a graphical representation of some of the data entities used in the system and their inter-relationships.

FIG. 3 is a graphical representation of some other concepts used in connection with the system and their inter-relationships.

FIG. 4 is a flow diagram illustrating operation of the client-side software with respect to the continuous collection of contextual information in accordance with one embodiment.

FIG. 5 is a flow diagram illustrating operation of the client-side software with respect to the collection of behavioral and contextual information in response to a triggering behavior in accordance with one embodiment.

FIG. 6 is a flow diagram illustrating operation of the server-side software with respect to the processing behavioral and contextual information received from the client-side software in accordance with one embodiment.

FIG. 7 is a flow diagram illustrating operation of the client-side software with respect to the collection of contextual information irrespective of a triggering behavior in accordance with one embodiment.

FIG. 8 is a flow diagram illustrating operation of the server-side software with respect to the processing of contextual information provided by the client-side software in accordance with one embodiment.

FIG. 9 is a flow diagram illustrating operation of the server-side software with respect to the creation of behavior models in accordance with one embodiment.

FIG. 10 a flow diagram illustrating operation of the client-side software with respect to the generation of Inference Query for the server-side software in accordance with one embodiment.

FIG. 11 is a flow diagram illustrating operation of the server-side software with respect to the processing of Inference Queries received from the client-side software in accordance with one embodiment.

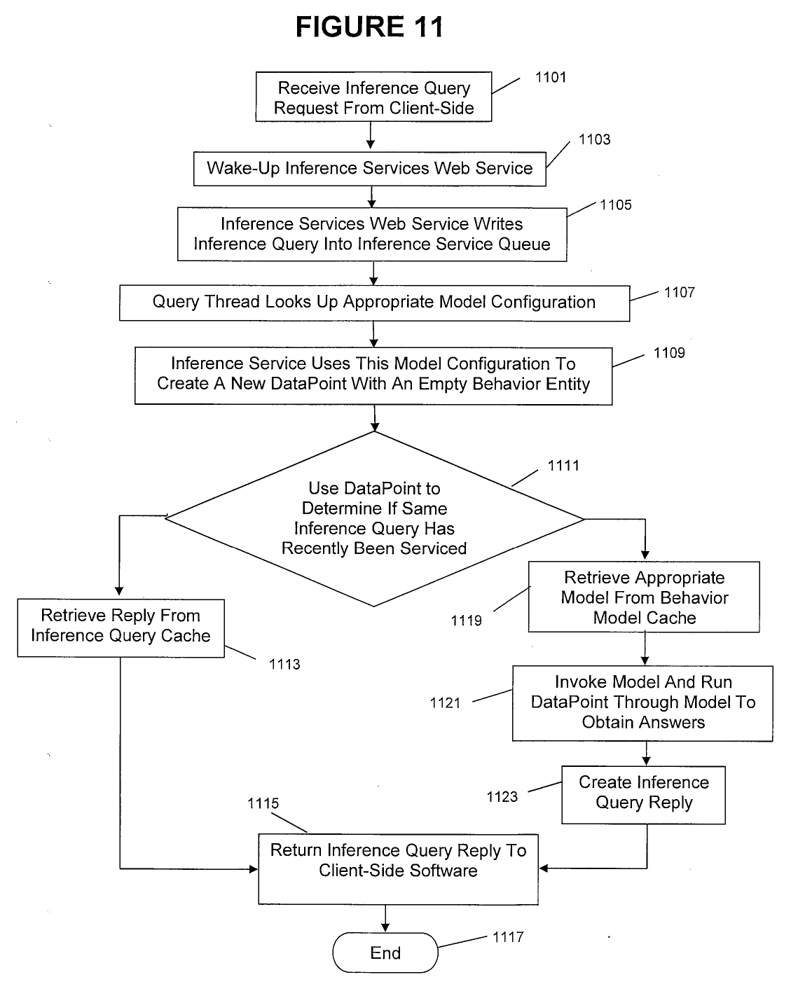

### DETAILED DESCRIPTION

Systems, apparatus, and methods are disclosed for predictively adapting properties of devices as a function of a user's historical behaviors (e.g., habits) as well as a function of the specific context within which such behaviors are displayed. Such context can be virtually anything, such as day of the week, time of day, temperature, weather, the user's mood, the user's location, the time of year, the score of the previous days sports games, the tides, the phase of the moon, etc.

Virtually any type of device can be adapted in accordance with the principles discussed in the present disclosure. This includes software systems, network software, mechanical systems, and biological systems.

Many cell phones allow the owner to customizer the user interface, such as by programming speed dial numbers or “hot keys”. However, the user must manually customize the interface. Furthermore, any such customization is permanent in the sense that the interface will remain the same unless and until the user manually changes it again at a later time.

The techniques, software, systems, methods and apparatus disclosed herein provide a vast improvement over the state of the art. Particularly, in accordance therewith, the user interface and/or other operational parameters of a consumer device, such as a cellular telephone, are customized automatically based on observations about the historical uses of the device and on the context of such uses. In other words, based on observations by software disclosed herein, the user's habits and the context within which those habits are observed are recorded and the device is automatically customized based on the user's behavioral patterns and the context thereof.

For purposes of illustration and clarity, let us consider a very specific example of an application of the principles, apparatus, techniques, methods and systems disclosed herein before describing them in detail. Particularly, let us consider a combination cellular telephone/personal digital assistant (hereinafter “wireless PDA”). Many people have very particular patterns of use of their wireless PDAs, depending on the time of day. For instance, an exemplary white collar male may use his phone rarely on weekdays between the hours of 12 AM and 6 AM (e.g., because he is sleeping). Furthermore, he may use it relatively rarely between the hours of 6 AM-9 AM, but when he does use it during those hours, it is usually to check the scores of the previous evening's professional sports competitions, to check his calendar for appointments that day, and/or to call his wife's cell phone. On the other hand, between the hours of 9 AM and 5 PM, the phone is rarely used (e.g., because he is at work), but when used, it is commonly to use it as a financial calculator (e.g., because he is an accountant). Finally, between the hours of 5 PM and midnight, it is used frequently to make and receive telephone calls to and from many different persons.

Cellular telephones and wireless PDAs have an idle screen, i.e., the screen presented when the phone first wakes from sleep mode. Merely as one example, the techniques, systems, apparatus and methods discussed herein can be used to present a customized idle screen for the wireless PDA based on context. Thus, during the hours of midnight to 6 AM on weekdays, the cellular telephone idle screen may be unchanged from the factory default settings. However, during 6-9 AM on weekdays, the idle screen may be reprogrammed to show the user's calendar (and particularly a single day view) occupying most of the screen but also showing a speed dial button for his wife's cellular telephone and a hot key providing single key access to a sports website that provides sports scores from the previous day.

Then, between the hours of 9 AM and 5 PM on weekdays, the idle screen can be programmed to show a different view reflective of the user's typical behavior during those hours of the day on week days. Thus, between 9 AM and 5 PM on weekdays, the idle screen may be programmed to display the financial calculator function of the wireless PDA.

Then again, from 5 PM to midnight, the idle screen is reprogrammed to present a different user interface as a function of the user's observed habits in terms of use of that device during those hours of the day. In the example above, this may be a conventional telephone interface.

As previously noted, the above-described exemplary embodiment for customizing the idle screen of a cellular telephone/wireless PDA based solely on behavior observed at each time of the day is merely exemplary. The technology is designed so that its software can easily be plugged into and adapted for use in connection with virtually any other software regardless of platform or protocol.

In one embodiment particularly adapted for use in connection with networked devices, some portions of the software are stored on the individual networked, client devices, whereas other portions of the software are stored at a separate, server node on the network, accessible to all of the networked devices. Such an embodiment minimizes the processing load in the networked device to preserve battery life and also allows the network-based portion of the software to be used by many devices on the network. Thus, for instance, in the above described wireless PDA example, the network-based software can be used to assist in the customization of the idle screen of thousands of different network subscribers' wireless PDAs. Furthermore, through the collection of data from thousands of users, the customization routines can be improved for everyone. Even further, it is envisioned that, the system discussed herein will often be able to customize the device better than the user could customize it himself or herself. Particularly, persons often are not aware of the full capabilities of their own devices. Furthermore, persons often are not even fully aware of their own habits.

The relevant systems, techniques, apparatus, and methods will now be described in more detail in connection with a network-based embodiment that can be used, for instance, to customize the idle screen of a wireless PDA, such as described above.

The features discussed herein may be implemented by a collection of inter-operating software data types, sub-systems, interfaces, and services, which together collect, analyze, and disclose patterns in datasets accumulated by them. It may be used within a network as a network service offering and be configured to collect and accumulate data from multiple sources (devices, operating systems, software applications, geo-location sites, network services, etc.) related to a network subscriber's (1) expressed behavior and (2) ambient context. That is to say, (1) what it was a subscriber did and (2) what the circumstances were under which the subscriber did it.

The features will practically be implemented as software that preferably, but not necessarily, runs at least partially on the device whose behavior it is to be modified or controlled. The system is a software engine (hereinafter sometimes referred to as the Engine) that determines user preferences as a function of tracked user behavior and the context in which that behavior is observed and helps control the device as a function thereof. The software engine collects and processes data as to the uses of a device and the context of such uses to create a mathematical model of subscriber behavior as associated with particular contexts. That model can then be analyzed for patterns of behavior and the results of that analysis queried through several software interfaces. Other software interfaces within the software engine may provide the results of those queries to another software program that can use such information to customize the device as a function of those patterns of behavior.

The software engine provides predictive behavior information about a subscriber to that subscriber's device or devices (for instance, a cell phone or wireless PDA). The software within the device is then empowered to alter itself with this information to make the device “smarter” or more useful to the subscriber. In the case of a cell phone, the phone's operating system may choose to automatically initiate a phone call (perhaps only up to the point where the user must press the “SEND” key to actually initiate the call) on Tuesday, on the third week of the month, while the phone is on the train from New York to Philadelphia in response to (1) detection that the phone was picked up and (2) being informed by the software Engine that a subscriber always calls the same number after closing his or her laptop on Tuesdays, on the third week of the month, when riding on the train from New York to Philadelphia. Devices of this kind are called “anticipating devices” because they anticipate human behavior. The application of the system in this configuration can be extended to desktop operating systems, stand-alone software applications, social networks, etc.

In addition to the foregoing, the inventive software can be augmented with a “standard” rules engine and/or software agent interface, and used to initiate a series of “network actions” (like retrieving a web page, paying a bill, or changing the channel on the HDTV) as a result of the appearance of a pattern of subscriber behavior, within a specified context.

For the remainder of this document we will refer to any device, operating system, software application, social network, etc. external to the software engine, but influenced by it, as the Host System. Additionally, we will formally define:
“Expressed Behavior,” as an action or activity demonstrated by a subscriber that is capable of being captured electronically by one or more Behavior factors. For instance, a subscriber's use of a cellular telephone to check email can be captured by electronic means, by storing appropriate parts of the network traffic to the mail server as a Behavior factor. A subscriber's intention or thought to do such things cannot be captured, at least not with present technical means; and
“Ambient Context,” as the circumstances around which a subscriber might express a behavior. Context can encompass geo-spatial, temporal, emotional, and other domains, so long as the domain lends itself to electronic monitoring and data capture by Context factors.

It should be stated here that an assumption that lies at the heart of this discussion is that human beings are creatures of habit. Their behavior, while often appearing random, is in fact, a series of actions, performed, with “regularity” subject to a multitude of variables, which can be captured and analyzed. One approach to that analysis has its foundation in some of the work done in Knowledge Management (KM) systems that utilize Machine-Learning algorithms. This approach may be utilized here. As a consequence, some parts of the mathematics behind the systems, techniques, apparatus, and methods discussed herein will be well understood by ones skilled in such arts. However, their application to the problem of predicting human behavior will not be.

It may be helpful to think of the system's components as treating the Expressed Behavior of a subscriber and his or her Ambient Context as the text of a “book” on their lives. In the same way that the text of “War and Peace” can be analyzed for thematic patterns by KM systems using Machine-Learning techniques (or even by the newer algorithms, like Google's Page Rank), so too can these “life texts” be analyzed. Also, as Amazon.com once used the results of text mining analysis on various books to create a searchable “tag-cloud” about those books, so too can the results of the analysis produced by the system be put to good use.

That said, the remainder of this document describes exemplary component parts of the technology disclosed herein and their inter-operation.

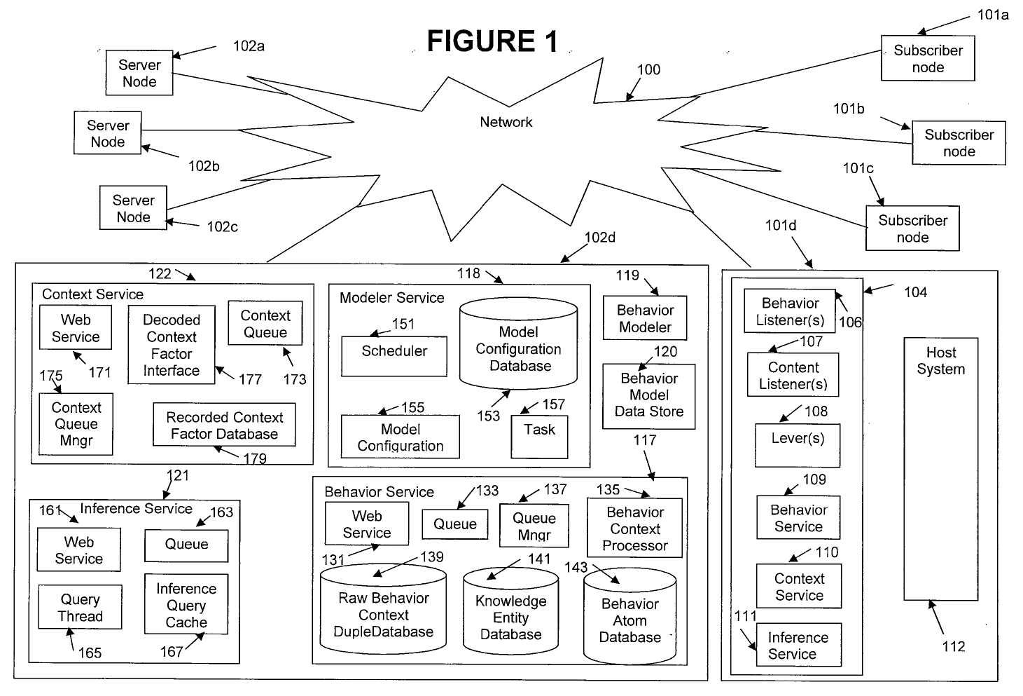

The system will now be described in a network-based embodiment with reference to FIG. 1.

### I. The Client and the Server

FIG. 1 illustrates a network 100, such as the Internet or a cellular telephone network, that supports any number of client devices 101a-101d and server nodes 102a-102d. Among the client devices are client devices configured in accordance with this disclosure, such as client device 101d. Also, at least, one of the server nodes, e.g., server node 102d, also is configured in accordance with the present disclosure and embodies software designed to work in conjunction with the client-side software to implement the features discussed in this disclosure.

In general, one way to think of the network-based embodiment is as a client-server combination, where the client-side code 104 is embedded into the subscriber's client device 101d and the server-side code exists at a server node 102d somewhere on the network, accessible through the network 100 in some way by the client device 101d. This division of the system is purely for convenience, as there is no requirement that the server and client remain separate. However, it is the case that this configuration permits a single server 102d to manage multiple clients 101, which, due to network effects, (the phenomena where adding an additional client or server to the network benefits all the clients and servers on that network) makes for a better overall experience for the subscriber. More directly, a single server configured in accordance with this disclosure would be able to algorithmically leverage the behavior and context data from multiple clients to make more accurate predictions for each individual client. In effect, each client would become “smarter” by the addition of one additional client and its resultant behavior and context data.

The client-side software 104 is responsible for monitoring a subscriber's expressed behavior and ambient context, capturing it, and transmitting it to the server 102d. In addition, the client software 104 is the agent used by the subscriber's Host System 112 to query the mathematical models created by the server-side code for an indication of a subscriber's likely behavior.

The server-side software, by contrast, is responsible for collecting the captured behaviors and contexts, processing them into a form that has mathematical meaning (i.e., a model), initiating an analysis on that processed data, accepting queries from the client, and returning results. We now turn to a more thorough discussion of the sub-systems that make up the client and server.

A. The Client

The client-side software 104 breaks down into six major components, namely:
1. the Behavior Listener 106,
2. the Context Listener 107,
3. the Lever 108,
4. the Behavior Service 109,
5. the Context Service 110, and
6. the Inference Service 111.

Although our discussion will presume that all of these components are part of a single collection of code 104 and resident within a client device 101d, they need not be, as long as all the components that need to be accessible to one another are so accessible.

1. Listeners and Levers

The Behavior Listener 106, Context Listener 107, and Lever 108 components are the most invasive pieces of code to the subscriber's Host System 112 and, as such, they are each subject to a great many changes from implementation to implementation. A detailed discussion of the Context Listener shall be given later, but the other components shall be discussed here.

a. The Behavior Listener

The job of the Behavior Listener 106 is to monitor the behavior of the subscriber and establish a means of codifying that behavior with one or more Behavior Factors. (Behavior Factors will be discussed later as part of the discussion of the Behavior Service). The Behavior Listener's activity is to be accomplished within a framework consistent with the portions of the Host System 112 that the Behavior Listener 106 touches.

In one implementation, the Behavior Listener 106 may be designed as a thread within a Host System that remains idle or asleep most of the time. When awakened by an activity performed by the subscriber, i.e., a trigger event (and usually this is accomplished by putting a one-line trigger of some kind within the source code of the Host), the Behavior Listener thread quickly acquires the appropriate behavior information related to the activity (i.e., an instance of behavior), as well as all available context (provided by the Context Service 110) and places an object containing this data (called a Raw Behavior-Context Duple, which will be described later) into a queue within the Behavior Service 109. In general, the Behavior Listener 106 is designed to take up as few resources as possible within the Host System, and to run as quickly and efficiently as possible.

By way of example, let us consider a simple activity performed on a weblog or “blog” in accordance with the present disclosure. Were a blogger to create a post or message for the blog, the moment the HTTP-POST hit the blog server, a Behavior Listener 106, embedded into that blog server, would wake up. It would then capture the text in the body of the blog post as a Behavior factor along with associated metadata and then acquire Ambient Context. Having this data, the Listener would create a new Raw Behavior-Context Duple containing this data and place it into the Behavior Service. The Behavior Listener would perform these functions in parallel to the activities normally initiated when a blog post appears at a blog server.

b. The Lever

The Lever 108 is a little more difficult to define specifically because the code for it will vary greatly depending upon the intended use of the data returned by the server-side components. There may be any number of Levers in a client device. In a nutshell, Levers are the applications, agents, or software that allow the client device to acquire information about a subscriber's likely future behavior from the server-side components, while abstracting away the processes for how that information is determined. In this way, the Host System's designers need not know anything about how the software operates to take advantage of its benefits. A couple of examples should give some sense of the scope of what this means.

In the dynamic idle screen implementation described above, the Lever 108 is a piece of software that controls the screen painting portions of the code for a cell phone's first screen or “idle screen” (in mobile parlance). This idle screen Lever works in conjunction with the client-side Inference Service 111 to enable the client device 101d to create an object called an Inference Query and send it to the server-side components in server 102d. The specific nature of the Inference Query will be discussed below in connection with the discussion of the Inference Service 111. However, for this discussion, it should be sufficient to describe it as an object that contains a well-defined request for information about a subscriber's likely future behavior.

The response to that Inference Query, when returned by the server-side components of the Engine, will contain a list of all the behaviors (e.g., likely phone numbers to be called, SMS messages to be sent, and applications to be invoked) appropriate to that subscriber's current context (e.g., date, time, location, etc.). The Lever 108 within the idle screen will then configure the idle screen to display this data, granting a subscriber one-click access to the people, messages, and applications most important to him or her in that context. Thus, the idle screen Lever 108 minimizes or prevents a subscriber from needing to search through an address book to find a common contact, or to open a messaging application to get to a message. It does this by making the idle screen “dynamic” and hiding the specific details of how that dynamism is accomplished.

In a second exemplary Lever implementation, an RSS feed is controlled to supply a context-sensitive list of the URLs that a subscriber is most likely to want available at a given moment. In this example, the Lever is a web service, written and executed on an Internet server. When a browser hits the RSS feed URL, this web service Lever creates an Inference Query and sends it off to the server-side components. When the response is returned, the Lever transposes it into an appropriate XML format and returns the results to the browser.

In both examples, the Host System 112 (the mobile operating system and the browser) need know nothing about the formats or the particulars of the operation of the engine software to take advantage of its data. Metaphorically, the client device uses the Lever 108 to ask the question, “What does my subscriber care about right now?” and obtain an answer.

2. The Behavior Service (Client-Side)

The Behavior Service 109, because of its need to exist within a client device and interface with a Host System 112, can have many widely differing implementations. In general, however, it is a stand-alone piece of code (an application, service, thread, or process) that is designed to oversee the capture of behavior and context data from the Host System 112 and direct it to the server-side components in server 102d. As a consequence, it exists separately from the Host System's usual processes, and has access to the same network on which the server-side components of the software reside.

On startup, the Behavior Service 109 initiates one or more Behavior Listeners 106, which interact with each part of the Host System 112 in which behavior is to be captured. It also launches a timer, which will set the frequency with which the Service 109 will dispatch or “publish” its collected behaviors to the Engine's server-side components. The Service then idles until awakened by one or more of the Behavior Listeners 106 or the timer. When awakened by a Behavior Listener 106, which will generally be indicating that the Behavior Listener has captured a subscriber behavior in a Raw Behavior-Context Duple, the Service 109 will accept the Duple, and add it to an internal queue. When awakened by the timer, the Behavior Service will package up the queued up Raw Behavior-Context Duples and publish them to the Engine's server-side components.

Up to this point, the Raw Behavior-Context Duple has been discussed as having been created by the Behavior Listener. However, this is not always the case. In some implementations of the Engine's client-side code, the Behavior Listener only creates a Raw Behavior for delivery to the Behavior Service and the Behavior Service is then responsible for gathering the appropriate context from the Context Service and creating the Duple. This activity would occur as close in time and place to the creation of the Raw Behavior as possible to maintain the accuracy of the data captured. Likewise, some implementations of the Behavior Service 109 may perform all of the tasks of creating and queuing a Raw Behavior-Context Duple, using the Behavior Listener 106 as a trigger only. The Raw Behavior, Context, and Raw Behavior-Context Duple objects will be discussed in more detail below, after a discussion about the publishing mechanism of the Behavior Service.

Due to the different kinds of Host Systems and networks to which the Engine might be applied, the Behavior Service's publishing interfaces are designed with a high degree of flexibility. They are intended to support both PUSH and PULL modes of interaction with the Engine's server-side components. In a PUSH embodiment, the client initiates the interaction, and the data is delivered by a mechanism like an HTTP-POST. In this case, the client PUSHES the data to the server. In a PULL embodiment, the client-side Behavior Service 109 is implemented with a mechanism like a web service that permits the Engine's server-side components to initiate the interaction. In this case, the server, PULLS data from the client.

3. The Context Service (Client-Side)

For the same reasons as the Behavior Service, the client-side Context Service can have multiple differing implementations. It too tends to be a stand-alone piece of code (an application, service, thread, or process) that exists separately from the Host System's usual processes. It does not necessarily need to have access to the same network on which the Engine's server-side components reside, as there is no communication between the two. However, like everything else in the Engine, flexibility is desirable.

The primary function of the Context Service 110 is to establish an electronic representation of Ambient Context and capture that representation into a software object, namely, a Context Object representing an instance of contextual information. Like the Behavior Service 109, the Context Service 110 is idle or asleep most of the time, and publishes its objects for consumption by other services. In this case, the consumption is by the Behavior Listeners 106, the Levers 108, the client-side Behavior Service 109, and the Inference Service 111, and any other service within the Host System 112 that might want to make use of the information contained within a Context Object. Again, publishing encompasses both PUSH and PULL models.

a. The Context Listener and the Context Service (Client-Side)

On startup, the Context Service 110 creates a master Context Object and one or more Context Listeners 107, one for each Context factor that is to be monitored. Context factors will be discussed in more detail below. The design of the Context Listeners 107 is very similar to that of the Behavior Listeners 106 in that Context Listeners consume few Host System resources, are idle or asleep most of the time, and are responsible for awakening the idle Context Service 110. A Context Listener, however, does not create Raw Behaviors; instead, it supplies to the Context Service 110 a then current value for the Context factor under observation.

Byway of example, a Context Listener 107 on a wireless PDA 101c could be designed to awaken the Context Service 110 when that wireless PDA jumps cell towers. In this case, the Context factors under consideration would be the Cell Location Area Code and Cell Tower ID. Whenever either of these two factors changes, the Context Listener 107 awakens the Context Service 110, and supplies it with the latest values for those factors.

Upon receiving any Context factor changes, the Context Service 110 updates the Master Context Object and goes back to sleep. However, when another service alerts the Context Service that the Context data within the Master Context Object is required, the Context Service produces a copy of that Master Context Object and supplies it to the requesting Service. This is the PULL model. The Context Service might also periodically provide updates to the other services without being requested to do so. This is the PUSH model.

4. Raw Behavior, Context, and the Raw Behavior-Context Duple

Let us now discuss the various data types used in the aforementioned systems before continuing to a discussion of the Inference Service 111.

a. The Raw Behavior

The Raw Behavior is, in one exemplary implementation, a super class (in Object-Oriented Programming terms) that is sub-classed to produce specific Raw Behavior objects appropriate to the Behavior factors being captured by the Behavior Listener 106. The sub-classed Raw Behaviors can be further sub-classed depending on the requirements of the Host System. In general, each Behavior Listener 106 only operates on one type of Raw Behavior object, although there is no limitation in the design that requires this. For any given Host System and set of Behavior factors, a number of differing types of Raw Behavior objects may be required. An incomplete list of current or planned Raw Behavior types follows:
For capturing Mobile Originated (MO) and Mobile Terminated (MT) voice and data calls,
For capturing MO and MT text and binary messages (SMS & MMS)
For capturing e mails (incoming and outgoing)
For capturing notes, reminders, task lists
For capturing Weblog posts
For capturing highlighted text posted to a URL
For capturing clickstream (URLs visited with a web-browser)
For capturing instant messaging messages and chats
For capturing chat logs
For capturing music consumed though music software including web-based music players
For capturing PIM functions (calendar, address book, alarms, etc.)
For capturing file system accesses (open & closing a file etc.)
For capturing media capture and consumption (video, still images, uploads and downloads)
For capturing gaming activity
For capturing map service usage
For capturing system maintenance activity (backups, synching, password changes)
For capturing search strings

Each Raw Behavior will contain one or more fields of information (the Behavior factor) and metadata. Some of the fields captured as part of a subscriber behavior might include:
1. Subscriber's ID
2. Subscriber originated or subscriber terminated activity
3. Elapsed time of expressed behavior
4. Host System name (Pandora, iTunes, Safari, Firefox, email, document)
5. Internal states of activity within the expressed behavior
   a. For voice calls this might be: ringing, on-hold, missed call, etc. . . .
   b. For messaging this might be: created, read, deleted, received, saved
6. For a document or song track
   a. Titles and author or artist
   b. Length and size
   c. Category or genre
   d. Collection name (book title or album)
   e. URI, where appropriate
7. Person or persons (not subscriber) associated with behavior (From, To, buddy list member, etc. . . . )
8. Phone numbers or subscriber IDs of associated persons (not subscriber)
9. For a message, post, note, weblog post, etc. . . .
   a. Collection name (blog title, etc. . . . )
   b. Subject or title
   c. Subscriber-defined category or tag
   d. Text of the body of message
   e. Reference or highlighted portion of message
   f. URI, where appropriate
10. File names and types (MIME-types) associated with behavior (video file, song, etc. . . . )

The existence of a Raw Behavior indicates to the Engine that a behavior on the part of the subscriber has been expressed. However, negative behaviors (those that did not appear when predicted by the Engine) could also be electronically created and captured.

Furthermore, there is no temporal limitation on the capture of Behavior information by the Behavior Listener. That is to say, there is no requirement in the design that the Behavior exhibited by the user has actually “happened already” for the corresponding Behavior factors to be captured and used by the Engine. For example, consider the case where a subscriber has entered a calendar event into his wireless PDA of a meeting the following day. In one embodiment of the invention, the entry of that calendar event would create two Behavior triggers: one for the action of creating the calendar entry, and a second one for the action, not yet undertaken, of being present at the meeting the following day.

Both Behaviors would have appropriate behavior factors associated with them, and would produce Behavior-Context Duples from the Behavior Listener associated with the Calendaring application on the Wireless PDA. As an aside, such an embodiment would not be limited to using the then current Ambient Context to inform both Behavior-Context Duples. In such a case, the first Behavior Context Duple (the one containing the behavior representing the creation of the calendar entry) might contain the current Context, while the second (the one containing the action yet to be performed) might contain a Context that more accurately represents the time, date, and the location where the unperformed action would be performed, as might be derivable from the Calendar entry itself or other sources.

b. The Context Object

Like the Raw Behavior, the Context object tends to be a super class, sub-classed as dictated by the requirements of the Host System supplying the Context factors. This is significant, because not all Host Systems will be capable of supplying the Engine with a comprehensive set of Context factors. For instance, a cell phone or wireless PDA with a GPS radio will be able to provide geo-location information, while a desktop computer operating system without such a radio will not.

In most implementations, the Context Service will be defined as having a Master Context Object singleton, which is comprised of one or more Context factor fields, and multiple read-only Context objects, which will be created and deployed as needed to the remaining Services of the Engine or to the Host System. As each Context Listener establishes a value for the Context factor it observes, the corresponding field in the Master Context Object is updated. The following list represents an incomplete set of Context factors in the employ of the Context Service:
1. Location (geospatial, political, network location [IP address, virtual location, location within cellular network])
2. Network characteristics (signal strength, roaming status, QoS, bandwidth, etc.)
3. Times-of-day [real-time, network time, virtual time]
4. Subscriber Mood (emotional feedback)
5. Serial numbers of device in use (IMEI, IMSI, MAC address, etc. . . . )
6. Characteristics of device in use (silent vs. ringing modes, wired vs. wireless network use, etc. . . . )
7. Subjective location (home, office, car)
8. Surrounding devices (discoverable cell phones, printers, RFID tags, etc. . . . )
9. Surrounding networks (Bluetooth, zigbee, RFID, NFC)
10. Weather or temperature
11. Subscriber's phone number and/or subscriber IDs

It is worth noting here that some of the Context factors can only be supplied by substantial changes to the Host System (as is the case with number 4, subscriber mood) and some others must be subjectively defined by the subscriber, as is the case with number 7, subjective location.

For instance, in the specific case of subscriber mood, one implementation on a mobile device might be to extend the phone dialer application “End Call” button to include two softkeys, such that a phone call could be hung up by depressing any of three keys. Each key would then be assigned a mathematical value to indicate mood. The left softkey could be used to indicate Happy; the right softkey, Angry; and the End Call button could indicate No Change in Mood. Icons above each key could indicate to the subscriber which button was which.

When a subscriber hangs up a call, he or she would select one of the three buttons, depending on how he or she felt at the end of the call. This would enable the Engine to crudely capture the subscriber's mood.

c. The Raw Behavior-Context Duple

In simplest terms, the Raw Behavior-Context Duple is just an object that combines, without collapsing, the Raw Behavior and Context objects. The reason to make note of it here is that, in the majority of implementations of the Engine's client-side code 104, the Raw Behavior-Context Duple is not sent singly to the Engine's server-side components. A wrapper, usually in the form of an array or list, is employed so that multiple Raw Behavior-Context Duples can be published to the server-side software at once.

5. The Inference Service (Client-Side)

Like the Behavior Service 109 and the Context Service 110 (and for all the same reasons), the Inference Service 111 may have multiple differing implementations. Likewise, it also is most often designed to be a stand-alone piece of code (an application, service, thread or process) that is able to exist separately from the Host System's usual processes. It should have access to the network on which the Engine's server-side components 102 reside because its primary function is to act as the conduit for the Host System 112 to communicate with the Engine's server-side components. The vehicle for that communication is an object called the Inference Query, discussed in the next section.

In operation, the Inference Service 111 is idle or asleep most of the time, awakening to accept requests from a Lever 108 or from the Host System 112 directly. When a request is received, it will generally contain the type of behavior data sought by the Lever or the Host System, the format into which the reply to the request is to be transposed, and the security credentials of the Host System.

This information will be transferred and reformatted to be appropriate for an Inference Query, and will have a recent Context object (supplied by the Context Service 110) appended to it.

In some implementations, the Lever 108 or Host System 112 supplies its own Context details as a part of making a request to the Inference Service 111. When this occurs, the behavior data returned by the server-side components relates to those Context details, and not to the actual Ambient Context of the subscriber, as supplied by the Context Service. This process is often initiated when a specific or historical set of subscriber Behaviors is sought by the Lever or Host system. Referring to a previous example, if a subscriber would like to see on her dynamic idle screen what her likely behaviors were on Tuesday, last week, or two hours from now, or if she were in a different location, she could instruct the idle screen Lever to set the Context to be used in the request to the Inference Service to be consistent with last Tuesday, or two hours from now, or with that other location. The data returned from the Inference Service would then reflect the Behaviors associated with those Context parameters, and not with her actual, current Ambient Context, as it would have been specified by the Context Service.

In one embodiment, the Inference Service includes a cache that stores previous Inference Queries and replies thereto received from the server-side portion of the Engine. This cache is designed to minimize the number of exactly matching Inference Queries made by the client-side portion of the Engine within a specified period of time. The duration of items remaining in the cache may be tightly controlled such that replies to Inference Queries that are too old to be reliable are not relied upon.

The newly created Inference Query will then be tested for a match with any previous Inference Query and corresponding reply contained in the internal cache. If the Inference Query does not match one in the cache, it is dispatched to the server-side portion of the Engine by the Inference Service 111, which will wait for a reply.

Upon receipt of the reply, the results will be placed into the cache for later matching, and then reformatted to be consistent with the initial request by the Lever 108 or Host System 112. The reformatted results are then delivered to the calling service or system.

a. The Inference Query, the Behavior Atom, the Datapoint, and the Knowledge-Entity

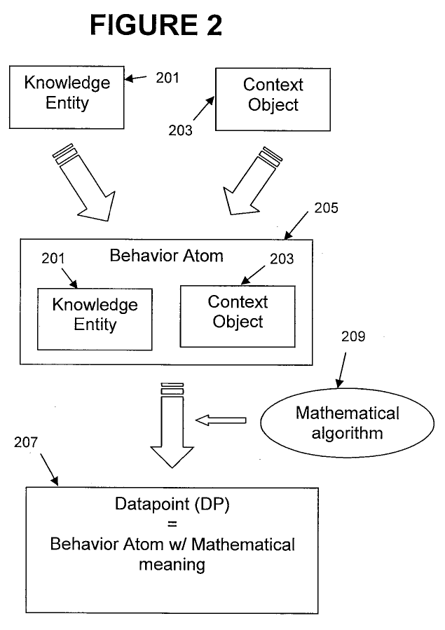

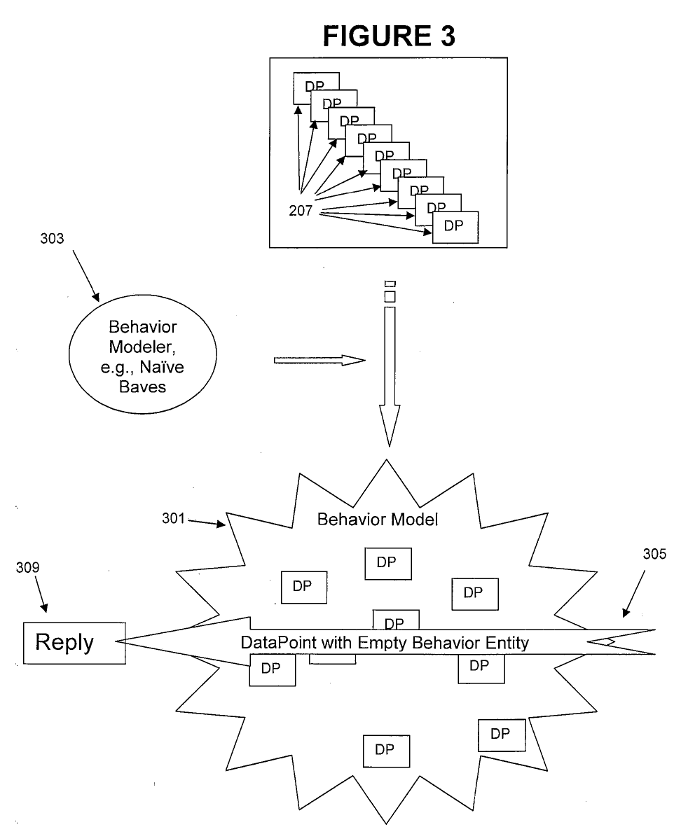

Before a more meaningful discussion of the Inference Query can ensue, the most fundamental data type to the Engine, the Knowledge-Entity, and its mathematically meaningful cousins, the Behavior Atom and the Datapoint, must first be described as well as the concept of a Behavior Model. Reference may be had to FIGS. 2 and 3 during this discussion for a visual representation of the interrelationship of these various entities.

A Knowledge-Entity 201 is the smallest bit of knowledge that the system can capture and store. In general, it is defined as an object that contains these common parts:
1. A unique identifier of the entity
2. A unique identifier of the subscriber; and
3. A description (or name) for the entity

Additional parts may be added, but every Knowledge-Entity 201 will contain the above. That said, Knowledge-Entities could literally be almost anything that can be electronically represented. Some examples include:
1. The phrase “For Whom The Bell Tolls”
2. The application iTunes
3. The phone number +1 (212) 555-1234
4. The concept “Peace”
5. The hexadecimal number 0x53CF0D778E
6. The date Sep. 24, 1997
7. The URL http://www.google.com
8. The song title “History Repeats Itself”
9. The geo-spatial coordinates “37° 24′ 53.64 N, 122°5′33.6 E”
10. The mood “Happy”
11. The event, “Dinner with Mom”
12. The relationship operand that establishes that Frank is the subscriber's father
13. The event operand that establishes that Sep. 24, 2007 is a Monday
14. The piece of Common Sense knowledge that says the sky is blue.

In general, a Knowledge-Entity 201 will fall into one of these categories (however, this list is not complete and the category names are subject to change):
1. Person
2. Place (which may indicate objective (e.g., 1700 Pennsylvania Avenue, Washington, D.C.) or subjective locations (e.g., home), even those that may be inferred from non-location-specific context data (e.g., it is 3 AM and the phone has not moved in three hours))
3. Application
4. Concept
5. Thing
6. URI (Clickstream)
7. Media Document (Song, video, book [Music])
8. Event
9. Emotion
10. Relationship
11. Operand
12. Piece of Common Sense Knowledge

Referring to FIG. 2, a Knowledge-Entity 201 when combined with a Context Object 203 is referred to as a Behavior Atom 205. When that Behavior Atom is transformed by a mathematical algorithm 209 such that it has mathematical meaning, it is called a Datapoint 207. Referring now to FIG. 3, multiple Datapoints 207, when arranged in a mathematically meaningful way using a suitable modeling algorithm 303, such as Naïve Bayes, and combined with a software engine for performing a mathematical analysis of that arrangement, are collectively called a Behavior Model 301. Models are generally given subjective names by the subscriber through a configuration process.

In some implementations, Behavior Atoms 205 are designed to contain multiple Knowledge Entities 201 and/or Context Objects 203. In an exemplary implementation, an additional factor (a parameter representing a degree of randomness) may be added to such a Behavior Atom, such that the value of that Behavior Atom with regard to Knowledge-Entities and Context Objects is non-deterministic. That is to say, that those values will change over time, in a non-predictive way. The value of such exemplary implementations is to introduce into the Behavior Model a degree of “Serendipity” or “Forgetfulness” into the Engine.

A more formal discussion of these data types is provided below in the discussion of the Engine's server-side components. However, the description above is sufficient to provide the basis for understanding an Inference Query.

Thus, given the above, the Inference Query 305 is an object that contains the following parts:
1. A Unique subscriber ID
2. A Security token
3. The Context for the Inference Query 305 to the server, generally supplied by the Context Service 110. The context will be composed of one or more of the following Context factors:
   a. Locations (geospatial, political, network location [IP address, virtual location, location within cellular network])
   b. Network characteristics (signal strength, roaming status, etc. . . . )
   c. Times-of-day [real-time, network time, virtual time]
   d. Mood (emotional feedback)
   e. Serial numbers of device in use (IMEI, IMSI, MAC address, etc. . . . )
   f. Characteristics of device in use (silent vs. ringing modes, wired vs. wireless network use, etc. . . . )
   g. Subjective location (home, office, car)
   h. Surrounding devices
   i. Surrounding networks (Bluetooth, zigbee, RFID, NFC)
   j. Weather or temperature
   k. Subscriber's phone number or subscriber IDs
4. The Name of the Behavior Model to be used to generate a reply to the Inference Query
5. The category of the Knowledge-Entities about which the Query is directed. For instance, one of the following:
   a. Person
   b. Place (which may indicate objective or subjective locations, even those that may be inferred from non-location-specific context data)
   c. Application
   d. Concept
   e. Thing
   f. URI (Clickstream)
   g. Media Document (Song, video, book [Music])
   h. Event
   i. Emotion
   j. Relationship
   k. Operand
   l. Piece of Common Sense Knowledge
6. The number of Knowledge-Entities that are to be included in the response to the Query.

This concludes a description of the client-side components of the Engine.

### II. The Server

The server-side code for the Engine may be considered to break down into six parts:
1. The Behavior Service 117
2. The Modeler Service 118,
3. The Behavior Modeler 119,
4. The Behavior Model 120,
5. The Inference Service 121, and
6. The Context Service 122

Although the following discussion presumes that all these components are part of a single collection of server code, they need not be, so long as all the components that need to talk to each other are accessible to one another (i.e. they share the same network). In some implementations, the Modeler Service 118 may be explicitly broken out from the other Services, for the sake of scalability since its processing tends to be computationally intensive and, therefore, detrimental to the performance of other services when active.

The following discussion elaborates on each of these components in turn.

A. The Behavior Service (Server-Side)

The server-side Behavior Service 117 within the Engine is usually implemented as a stand-alone server process that is designed to manage multiple simultaneous connections from various client-side Behavior Services. In one implementation, the Behavior Service 117 occupies a single TCP/IP port, although there is no such restriction in the architecture. The primary function of the Behavior Service is to transform the Raw Behavior-Context Duples supplied by the client-side Behavior Services into Behavior Atoms for storage in a database. To do this, the Behavior Service 117 must dissect each Raw Behavior within the Duple into its various Behavior factors, and then break down those factors into Knowledge-Entities. The Entities are then converted into Behavior Atoms through the application of the Duples' Context object. To perform these tasks, the Behavior Service 117 may (and often does) rely upon external systems, some of which will be mentioned here.

Since the transformations of the Raw Behavior-Context Duples into Behavior factors and then into Knowledge Entities can be computationally and memory resource intensive, this transformation preferably is not attempted on the client device 101d or services providing the Duples (the client-side code). Additionally, as previously stated, some of the transformations will depend upon information supplied by external support systems to the server-side Behavior Service 117, and as such would not necessarily be available to the client device 101d or services providing the Duples. Having said all this, should a client device or service be capable of supporting the computational and memory resource requirements of the transformation, such a transformation could be accomplished on the device supplying the Duples, eliminating the need for the Raw Behavior-Context Duples altogether.

The Behavior Service 117 may break down into several components:
1. A Web Service 131 for accepting a List or Array of Raw Behavior-Context Duples from the client-side, or for requesting a List or Array of Raw Behavior-Context Duples from the client-side;
2. A Queue 133 for temporarily receiving the duples;
3. At least one Behavior-Context Processor 135, which examines each Duple and breaks it up into one or more Behavior Atoms. The Behavior Atoms are, in turn, transformed by the Processor into Knowledge-Entities;
4. A Queue Manager 137, which, when notified of the existence of Duples in the Queue, examines the List or Array of Duples and determines which Behavior-Context Processor should be initiated to process each Duple; and
5. Three relational databases:
   the Raw Behavior-Context Duple Database (RBCD DB) 139, which stores Raw Behavior-Context Duples;
   the Knowledge-Entity Database (KE DB) 141, which stores the processed Knowledge-Entities; and
   the Behavior Atom Database (BA DB) 143, which stores Behavior Atoms, once processing is complete.

In operation, the Queue Manager 137, upon being notified that the Web Service 131 has successfully accepted a List or Array of Raw Behavior-Context Duples and placed that object into the Queue 133, will immediately examine the contents of the List or Array. For each Raw Behavior-Context Duple, the Manager 137 will determine the appropriate Behavior-Context Processor and initiate the activity of that Processor 135.

The Processor will then extract each Duple from the Array or List, examine that Duple, and then extract the individual Behavior factors within that Duple. In most cases, a single Duple will be transformed into a number of Behavior factors. Those factors are then broken into one or more Knowledge-Entities. The specifics of how this is accomplished will be discussed shortly, as will the additional processing performed on the Knowledge-Entities before they are stored in the Knowledge-Entity Database 141.

Once the Knowledge-Entities have been produced, the Processor pairs those Entities with the Context object from the Duple under examination. With the combination of these two objects, the Entities become Behavior Atoms. If additional metadata exists (usually from sources apart from the Duple and the Behavior Service), it will be added to the Behavior Atom at this stage; for instance, stem-relationship metadata from an NLP (Natural Language Processing) Engine.

In some cases, these external services when interacting with the Behavior-Context Processor 135 will result in the production of new Knowledge-Entities, apart from those in the Behavior-Context Duple. In something of a virtuous-circle, the Knowledge-Entities from some Behavior-Context Processors will be processed by external services and the resultant data returned back to the Behavior-Context Processor 135 for additional processing. The end result of this feedback loop is the production of additional Behavior Atoms.

Once this process is complete, the completed Behavior Atoms are stored into the Behavior Atom Database 143. Likewise, the Raw Behavior-Context Duples are stored in the Raw Behavior Context Duple Database 139 and the Knowledge-Entities (after additional processing) are stored in the Knowledge Entity Database 141. In the case of the Raw Behavior-Context Duples, this storage allows for eventual processing by other systems, most of which will be outside the scope of this specification.

By way of example, consider a case where the Raw Behavior-Context Duple was created from an activity where a subscriber happily “highlighted” or selected some text on an e-book reader configured in accordance with the principles of this disclosure. The highlighted text might be “for whom the bell tolls,” and this action might be performed at 3 PM on Wednesday, June 1st, at the subscriber's home. The following Behavior Atoms might be created as a result of processing by the Behavior-Context Processors 135:
A Media Document Atom with “for whom the bell tolls” as metadata, to indicate that the behavior was expressed from an e-document;
A Place Atom indicating the subscriber's home (possibly with a reference to that location's GPS coordinates);
An Emotion Atom for “happy” (the subscriber's mood);
An Application Atom for e-book (i.e. that an e-book was the Host System); and
Several Individual Concept Atoms for each of the words of the highlighted text (minus stop-words like “the” in most cases).

The metadata for these last Concept Atoms would not normally be wholly created by the Behavior-Context Processor itself, but by an external Natural Language Processing Engine that would apply traditional text mining techniques, like stemming, and TF-IDF to produce the metadata. In an example of the aforementioned virtuous-cycle, this NLP Engine would then feedback this metadata into the Behavior-Context Processor 135, which would then transform that metadata into Knowledge-Entities, and then into Behavior Atoms. The explanation for why this is, leads into the next section.

1. The Behavior-Context Processor

The work of the Behavior-Context Processors 135 tends to be a simple, one-to-one or one-to-many translation of Behavior factors into Knowledge-Entities, along the lines of a lookup table. This has been done deliberately, both to make the mapping of the two domains explicitly human-readable (when human inspection of the data is attempted), and to facilitate speedy process completion. When a more complicated translation mechanism is required, an additional domain-specific processor is usually brought to bear, as is the case when a Natural Language Processor is introduced to process some raw, unstructured text that may be a part of a Behavior factor.

In one implementation, this one-to-one or one-to-many translation may be “hard-wired” into the code. That is, any one Behavior factor will always map to one or more pre-determined Knowledge-Entities, differing only by the metadata that might be associated with that Knowledge-Entity. This process, however, could be made dynamic, or subject to the impact of a mathematical algorithm. It could even be made subject to the output of the Engine itself, making the translation of Behavior factors to Knowledge-Entities fully Context and/or Behavior-sensitive.

Whenever new Behavior factors are introduced into the system, changes to the Behavior-Context Processors 135 are usually required, whether or not the new factors are part of an existing Raw Behavior. These changes are usually limited to altering the one-to-one or one-to-many mapping of Behavior factors to Knowledge-Entities.

2. Knowledge-Entity Post-Processing

As previously discussed, a Knowledge-Entity is the smallest bit of knowledge that the system will capture. Each entity is unique and is made up of these common parts:
1. Unique identifier for the entity
2. Unique identifier for the subscriber
3. Description (or name) for the Entity

Additionally, Knowledge-Entities will likely contain metadata related to, but not necessarily extracted from, the Raw Behavior-Context Duple. For example (building from our previous example), a Knowledge-Entity that contains the description, “for whom the bell tolls,” may also have additional attributes, provided by external means, which could include:
1. Author
2. Length (of the work from which the text was extracted)
3. Genre
4. ISBN Number, and
5. URI (where appropriate).

The Behavior-Context Processors 135 create new Knowledge-Entities dynamically whenever it is discovered that no matching entity currently exists within the Engine. The matching performed here is done by the Behavior-Context Processors against the aforementioned Knowledge-Entity Database 141. When new Knowledge-Entities are created, they are given an initial weight or attribute of “activeness.” This attribute acts as a kind of filter, indicating the degree to which Behavior Atoms containing this Knowledge-Entity should or should not be included in Behavior Models that will eventually be created by the remainder of the Engine. We will discuss the use of this attribute more specifically when we discuss the activity of the Modeler Service 118.

The value of this “activeness” attribute can be controlled by the subscriber or dynamically controlled by a mathematical algorithm, as is the case with the Knowledge-Entities of Concept Atoms, which may be controlled by a modified TF-IDF algorithm. In one implementation, all Knowledge-Entities (except those related to Concept Atoms) are set with a maximum degree of “activeness.” In another, “activeness” may be impacted by the frequency with which the Knowledge-Entity appears among the subscriber's Raw Behaviors.

B. The Modeler Service

Like the server-side Behavior Service 117, the Modeler Service 118 is generally implemented as a stand-alone Server Process. It is responsible for preparing datasets from the database of Behavior Atoms to eventually produce a data structure called a Behavior Model. The Behavior Model is a mathematical representation of a subscriber's historical behavior within boundaries described by a specific range of Contexts that will be discussed in detail below.

The Modeler Service 118 is broken up into four parts:
1. the Model Configuration 155;
2. the Model Configuration Database 153;
3. the Task 157; and
4. the Scheduler 151.

The Model Configuration 155 is a set of parameters that spell out the following:
1. The Context boundaries of the dataset that will eventually be used to create the Behavior Model (this is usually specified as a range of Context Attributes);
2. The degree of Knowledge-Entity “activeness” that is to be used to filter out unwanted Behavior Atoms from the dataset;
3. The algorithm or Behavior Modeler that is to be used on the dataset to create the Behavior Model (specifics of the Behavior Modeler will follow in our discussion of the Behavior Model);
4. A Transformation Template (to be described later) that details information useful to the Behavior Modeler; and
5. The frequency with which the Behavior Model should be created. Note, this frequency is completely independent of the Context Range specified in the configuration.

The Modeler Service 117 will store multiple Model Configurations for one or more subscribers in the Model Configuration Database 153, the second part of the Model Configuration Service 117.

The third part of the Modeler Service is the Task object 157. It is generally implemented as a thread responsible for executing the procedures necessary to create a Behavior Model. When created, the Task is given a Model Configuration and a URI to the Behavior Atom database from which it will derive its dataset. When executed, the Task 157 acquires the requisite dataset and passes it to the algorithm or Behavior Modeler 119 specified in its Model Configuration 155. Once the Modeler has completed the creation of the Behavior Model, the Task object 157 stores the Behavior Model in a separate data store. This store in one implementation is a cache that is persisted by either a relational database or file system.

In one embodiment, the Model Configuration 155 is implemented such that its parameters constrain the Task object 157 to apply its dataset to a single Behavior Modeler 119. In other embodiments, the Task object 157 may be more flexible and its Model Configuration 155 augmented to allow the Task object to pass its dataset into multiple Behavior Modelers 119. The multiplicity of Behavior Models created in such a scenario would then be used to allow the server-side Inference Service 121 (which remains to be discussed) to run a series of queries against this set of Behavior Models. These queries would be performed dynamically and simultaneously to determine the “best” Model to use to produce the “most satisfactory” result. The “best” model and “most satisfactory” result will be very much dependent on the intended purpose for the query's result.

The fourth and final part of the Modeler Service 118 is the Scheduler 151. This is a Thread that is responsible for periodically authorizing the Task object 157 to perform its operation. Because the design of the Scheduler 151 is fairly common, it will not be discussed in depth here, except to say that the Scheduler 151 is designed such that multiple Task objects may run simultaneously, and that the Scheduler 151 uses the Model Configuration 155 in each Task object 157 to govern its scheduling.

1. The Behavior Modeler & The Behavior Model

The Behavior Modeler 119 is an object that is executed within the context of the aforementioned Task object 157. It is responsible for transforming the dataset acquired by the Task object 157 from its initial state as a subset of data from the Behavior Atom database 143 into a Behavior Model, which we will now define as a “cloud of Datapoints” that can be manipulated by a mathematical algorithm. What is meant by “cloud” will be described shortly, as will the structure of the Datapoints. This data transformation can be considered as a three-step process, which can be described as follows:
1. Pre-processing the Context into Context Values
2. Creating the “Cloud” of Datapoints, and
3. Selecting the Behavior Modeler Algorithm.

When the work of the Behavior Modeler 119 is complete, a “mathematically meaningful,” model of the subscriber's historical Behavior and Ambient Context will have been created. This model is, in fact, a complex data structure that represents a multi-dimensional Context Coordinate system of Datapoints combined with an Algorithm that is the embodiment of one or more mathematical or machine-learning algorithms.

2. Behavior Modeler Algorithms

The Modeler Service 118 contains multiple Behavior Modelers, one for each of the Behavior Modeler Algorithms it supports. The choice to support multiple algorithms for the prediction functionality of the Engine is deliberate, as it is only logical that no single algorithm can be ideal in all circumstances.

Suitable Behavior Modeler Algorithms include machine learning algorithms, but other types of algorithms also can be supported. Behavior Modeler Algorithms envisioned for support by the Behavior Modeler design include, but are not limited to:
1. Na\ddot{v}e Bayes;
2. Hierarchical Naïve Bayes;
3. Hidden Markov;
4. Expectation Maximization;
5. Nearest Neighbor;
6. Centroid Classifier; and
7. Fractal Dimension.

Despite having multiple machine learning algorithms, each with diverging dataset requirements, the Behavior Modeler design is such that it exposes a generic set of APIs to each Behavior Modeler Algorithm, and to the infrastructure of the Behavior Modeler 119. Taking this approach allows for the creation of a multiple Behavior Modeler Algorithms, while allowing all the Behavior Modelers to appear the same to the Modeler Service 118 and for each Behavior Modeler to produce a Behavior Model with a consistent structure. We believe there to be a great deal of uniqueness to this approach. Also, this approach can be made generic enough to be applied to applications beyond that of the Engine.

3. Datapoints and The “Cloud”

The process of transforming the dataset of Behavior Atoms into a “cloud of Datapoints” is complex. First, each Behavior Atom in the dataset is transformed into a single Datapoint, the structure of which is defined by a Transformation Template within the Task object's Model Configuration. In a general sense, a Datapoint can be described as the Knowledge-Entity portion of the Behavior Atom combined with an array of Context Values, which themselves have been extracted from that same Behavior Atom. The extraction of the Context Values will be discussed shortly, but the intention behind their existence is to deconstruct the Ambient Context captured within the Behavior Atom into the equivalent of a coordinate in a multi-dimensional Context Coordinate system, i.e., a “metric space”, as it is defined in mathematical terms. Such a space has specific meaning within the Behavior Modeler Algorithms, which will depend upon this coordinate system when the Behavior Model is used to predict a subscriber's Behavior.

Taking a step back before we discuss the details of the creation of the Context Values, we can consider the Datapoint, as described above, as an “attribute” placed at the “coordinates” indicated by the Context Values within a multi-dimensional “cloud” of the Context Coordinate system. This metaphor will be especially helpful for the upcoming discussion of the server-side Inference Service, and, thus, deserves some elaboration here.

Using a simplified example, consider that a color may be associated as an attribute to a data point in a 3-dimensional (X-Y-Z) coordinate system. Each data point in this system will have an X, a Y, and a Z coordinate value, and a color, Q, that describes some real world characteristic (X,Y,Z,Q). If one has thousands of these colored data points and chooses to plot each of them, one would find that one may have created a colorful “cloud” of data points.

Extending the metaphor, the X, Y, and Z values of this “cloud” would each correspond to Context Values of the Datapoint, and the Knowledge-Entity would correspond to the color. Driving this to the specifics of the design of the Behavior Modeler 119, the “cloud” of Datapoints is a multi-dimensional data structure, where the Datapoints are arranged along axes defined by the Context Values. These Context Values relate directly to the Context Attributes that were indicated by the Task object's Model Configuration 155 as boundaries to the original dataset of Behavior Atoms.

Defining the Context Values in this way creates a limitation on the Behavior Modeler 119 in that the coordinate system of the “cloud” will only contain Context Attributes that were a part of the bounded dataset. So, for instance, it is possible within the Modeler Service 118 for a Context Attribute to be statistically significant to predicting a subscriber's behavior, and not be included in the eventual Behavior Model because that subscriber neglected to include that Context Attribute in the Model Configuration 155.

By way of example, if it happens that a subscriber only visits the “theweatherchannel.com” website when it's −5 degrees Celsius outside (e.g., because he likes to ski and is interested in where it is snowing when it is cold), but temperature was not included as one of the boundaries of the Context Attributes within the Model Configuration, the Behavior Modeler's Algorithm would not be able to establish that the temperature was a significant factor in the future behavior of that subscriber.

4. Pre-Processing and Creating Context Values

The multi-step process of extracting Context Values begins with the examination of each Context Attribute within the Context portion of the Behavior Atom by the Behavior Modeler 119. As a first step, the Context Attribute is transformed into a “numeric” or “nominal” representation of itself.

This numeric or nominal value is then recast into an object that captures, in its structure, both the characteristics of the Attribute being described, and the “mathematical meaning” of the Attribute. In literal terms this means that the numeric or nominal value is placed inside a new Context Value object that is specific to the kind or type of Context Attribute being described. For example, a Context Attribute for a temperature of −5 degrees C. would be transformed into a Celsius Temperature Context Value, with a numeric value of −5.

The reason for this transformation is that the new Context Value encapsulates software methods that define the “mathematical meaning” of the scalar value in terms consistent with those of the Behavior Modeler Algorithm that will be associated with the “cloud.” By “mathematical meaning” we effectively mean that the Context Value belongs to a well-defined metric space (i.e. that the metric space has a corresponding distance function that satisfies the axioms for reflexivity, symmetry, and the triangle inequality).

Once all the Context Values for the Behavior Atom have been created, they are placed into a specific order that in effect becomes an array. This array establishes the coordinate position of the Context Attribute within the multi-dimensional coordinate system of the Behavior Modeler Algorithm. This coordinate is then joined to the Behavior Atom's Knowledge-Entity, to become a Datapoint.

This process continues until each Behavior Atom has been transformed. The resultant “cloud,” is passed into a new Behavior Model, where is it joined by the Behavior Modeler Algorithm that was defined in the Task's Model Configuration 155.

C. The Inference Service (Server-Side)

The Inference Service 121 comprises four parts:
1. A web service interface 167 through which the client is permitted to make Inference Queries of the Engine;
2. a Queue or pool 163 to allow for multiple Inference Queries to be processed simultaneously;
3. a Query Thread 165 which executes the procedure of performing the query itself; and
4. an Inference Query Cache 167, which is checked with each query to ensure that exact duplicate queries are not performed within a period of time on the same model.

The Web Service 161 can be fashioned from any reasonable implementation of network interface software for receiving Inference Queries over the network.

In operation, first the Web Service 161 receives an Inference Query from the client code. As previously noted, the Inference Query contains:
1. Unique subscriber ID
2. Security token
3. The Context for the query. The context will be composed of one or more of the following attributes:
   a. locations (geospatial, political, network location [IP address, virtual location, location within cellular network])
   b. network characteristics (signal strength, roaming status, etc. . . . )
   c. times-of-day [real-time, network time, virtual time]
   d. mood (emotional feedback)
   e. serial numbers of device in use (IMEI, IMSI, MAC address, etc. . . . )
   f. characteristics of device in use (silent vs. ringing modes, wired vs. wireless network use, etc. . . . )
   g. subjective location (home, office, car)
      i. always subscriber defined
   h. surrounding devices or networks (Bluetooth, zigbee, RFID, NFC)
   i. weather or temperature
   j. subscriber's phone number or subscriber IDs
4. Name of Model to be used for the query
   a. Names are arbitrarily chosen by the subscriber when he or she creates model configurations. The model configuration names are the names of the models themselves.
5. Type of the Behavior Entities about which the query is directed. This will be one of the following:
   a. Person
   b. Place (not created by can be inferred from context data)
   c. Application
   d. Concept
   e. Thing

2f. URI (Clickstream)
g. Media Document (Song, video, book [Music])
h. Event
i. Emotion
6. the number of Behavior Entities that are to be included in the response to the Query.

The Inference Service 121 captures the Inference Query and uses the name of the model within the Query to look up the appropriate Model Configuration 155 to be used in creating a Datapoint. Once it has the Model Configuration, the Inference Service 121 uses the Model Configuration as a guide to effectively create a new Datapoint with an empty Behavior Entity. This Datapoint will be appropriate for application to the Model. The Context coordinate for this new Datapoint is created from the Context Attributes extracted from the Inference Query. Because not all Context Attributes will be appropriate for each Model that has been created, some filtering of the Context attributes may be performed. Once the DataPoint with the empty Behavior Entity has been created, the Inference Service 121 uses the Datapoint to do a lookup into the Inference Query Cache 167 to determine whether or not the system has recently run an analysis that would produce the same results as the one about to be run. The criteria for a match of the lookup are:
1. The Context coordinate of the Datapoint;
2. The Name of the Model; and
3. The type of Behavior being sought.

There should be an exact match to each of these criteria, in order for the results of the Cache 167 to be used. If not, the Inference Service 121 acquires the Model using the Model name and Behavior Entity name, and applies the Datapoint to the query interface of the Model. It is important to note that the Model, when created and named is intended to apply a single Behavior Modeler Algorithm to produce a set of results of only one Behavior Entity type. This is done for efficiency. The Behavior Modeler Algorithm, which was discussed previously, produces a ranked list of Datapoint-duples that satisfy the Context coordinate of the Datapoint that was applied to the Model. These duples are literally the Datapoints from the model, appended with a “confidence score” between 0 and 1 for how well that Datapoint matched the Context coordinate. This score is a by-product of the calculations performed by the Behavior Modeler Algorithm. The Inference Service then parses the ranked list to extract the number of Behavior Entities called for in the original Inference Query. Once that number of Entities has been acquired an object is returned to the calling client through the web service interface.

In the use by the Server-Side Inference Service described immediately above, the Knowledge Entity portion of a Datapoint is left unpopulated, so that it might be populated by the application of that Datapoint to the query interface of the Behavior Model. Alternately, the Context Values portion of the Datapoint may be left unpopulated, while the Knowledge Entity portion of that same Datapoint is populated. With this approach, the Datapoint, once applied to the query interface of the Behavior Model, will become populated by a ranked list of Context Values and a “confidence score”. Used this way, the Engine no longer predicts human behavior given a context, but predicts context given a human behavior of the subscriber. The Engine answers the question, “Under what set of circumstances should I expect the subscriber to perform this behavior or set of behaviors?”

This alternate approach yields a number of applications, particularly in the area of surveillance. In a law enforcement example, such a scheme would be a useful way to predict the location of a suspect, provided that access to the data stored in the Engine was available, and a list of tracked behaviors was at hand. For instance, with such an approach, a law enforcement official might be able to discern the expected whereabouts of a known felon, given only the information that he phones his mother on her birthday. An Inference Query could be fashioned from such data that could return the full set of locations where that known felon was present when such a call was made.

In another example, an advertising agency may wish to confirm the most effective times to show a financial services commercial to a subscriber, knowing that the subscriber is most susceptible to the marketing message after phone calls to his broker. By creating an Inference Query with the described Behavior, the agency could receive a ranked list of times when the commercial might be most effective.

D. The Context Service (Server-Side)

The Context Service 122 is a standalone process that functions very similarly to its companion process on the client-side. It has a notable difference, in that the server-side Context Service 122 does not manage a Master Context Object. It instead maintains a Context Database 179. This Context Database 179 is populated by a new Context-related object, called a Recorded Context Factor that will be described shortly. The primary function of the server-side Context Service 122 is to act as a look-up table to fill in gaps, which will appear from time to time in various Context objects supplied from the server-side Inference Service 121 and Behavior Service 117.

The Context Service breaks down into five parts:
1. The Context Service's Web Service 171;
2. The Context Queue 173;
3. The Context Queue Manager 175;
4. The Recorded Context Factor Interface 177; and 5. The Recorded Context Factor Database 179.

In practice, the Context Service's Web Service 171 routinely receives Context Objects from varying client-side Context Services 110. These Context Objects will each contain a number of Context factors, including a time-stamp. Upon receipt of these Context Objects, the Web Service 171 will place these Objects into the Context Queue 173, and notify the Context Queue Manager 175. Upon receiving such a notification, the Context Queue Manager 175 will acquire the Context Object from the Queue 173, and “unroll” it, extracting the independent Context factors. The Context Queue Manager 175 will then create a separate Recorded Context Factor Object for each Context factor, utilizing the time-stamp within the Context Object as a key. The new Recorded Context Factor will then contain the original Context factor and this key.

The Recorded Context Factors are stored in the Recorded Context Factor Database 179, which, in some implementations, is more accurately described as a Persistent Data Store, containing a cache and possibly a file system, instead of a relational database.

When either the server-side Behavior Service 117 or Inference Service 121 determine that the Context Object within a Raw Behavior or Inference Query is missing one or more Context factors, it performs a lookup of the Recorded Context Factor Database 179 using the Recorded Context Factor Interface. If the missing factors have been supplied by a different client, then those factors are returned to the Behavior Service 117 or Inference Service 121 to fill in the gaps to the Context Object.

By way of example, let us consider that a subscriber may be routinely browsing the web at his or her desktop machine configured in accordance with the principles of this disclosure. That machine will routinely supply the server-side Behavior Service 117 of the Engine with Raw Behaviors. However, since most desktop machines are not location-aware, the Context Objects supplied by the clients on those machines will be missing Location Context factors. However, if the subscriber is also carrying a mobile handset configured in accordance with the principles of this disclosure, which includes location-awareness, then Context Objects supplied routinely from that handset will include Location Context factors, and those factors may be used to fill in the gaps. It is for this reason that the server-side Context Service 122 was created.

### III. In Mathematical Terms

The Behavior Modeler Algorithms, as described earlier, are the embodiments of one or more mathematical or machine learning algorithms for predicting, based on the Datapoints in the “cloud” and the particular Inference Query, the subscriber's preferences. More specifically, they form part of the Engine's model, alongside a “cloud of Datapoints” that represents a subscriber's collected behaviors within a specific context. In use, these algorithms are provided a Datapoint with an empty Behavior Entity from the Engine's Inference Service, and produce a set of Behavior Entities and a confidence score.

Having described the client-side and server-side software components, a word about the Behavior Modeler Algorithms is in order. There are a number of well-known statistical modeling algorithms commonly used for predicting things based on a collection of datapoints, and virtually any of these may be used as a Behavior Modeler Algorithm in the present system. As previously noted, different Inference Queries may be better served by different statistical modeling algorithms (i.e., one statistical modeling algorithm may provide a more accurate prediction of the subscriber's preference in a given case than another). Any such algorithm can be readily adapted by persons of skill in those arts for use as one of the Behavior Modeler Algorithms.

### IV. Flow Diagrams

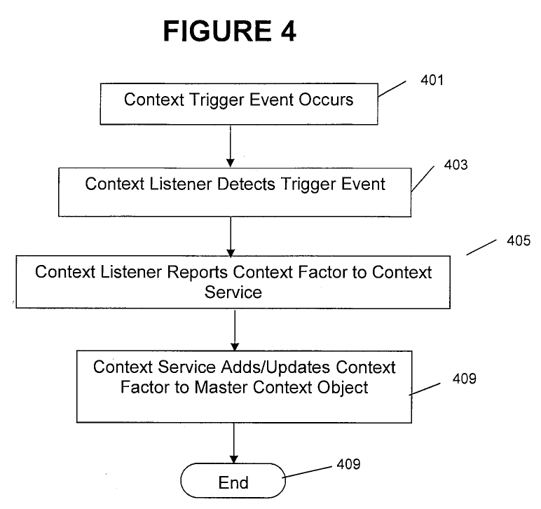

Having thus described the various components and operation of the invention, FIGS. 4-10 present a number of diagrams that help illustrate operational flow in accordance with various aspects of the present invention.

A. Continuous Collection of Contextual Information (Client-Side)

FIG. 4 illustrates the ongoing context information gathering process of the client side software, which regularly updates the Context Service 110 with the most up to date contextual information detected by the Context Listeners 107. In step 401, a triggering context event occurs. This might be nothing more than a timer set to go off every two minutes. Next, in step 403, the context event is detected by the Context Listener 107. The Context Listener 107 will then collect the context information in the form of a Context factor, which will then be reported to the Context Service 110 in step 405. In the last step 407, the Context Service will either add the new Context factor to the Master Context Object (if a value for that Context factor does not yet exist), or update an existing Context factor within the Master Context Object with the newly reported data. The process ends at step 409.

B. Collection of Behavioral and Contextual Information (Client-Side)

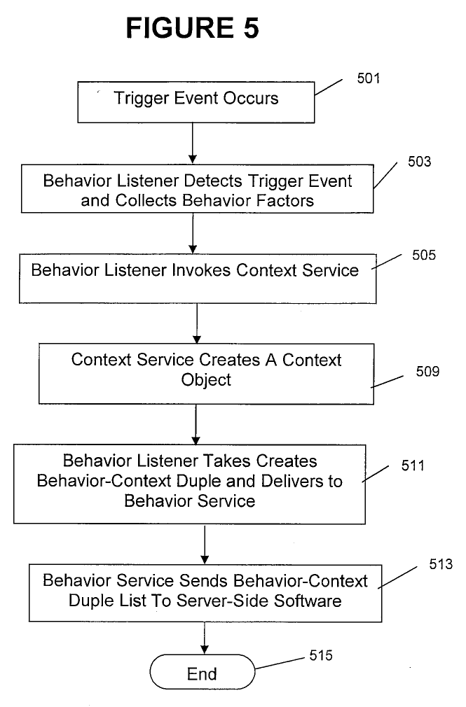

FIG. 5 illustrates an exemplary process flow of the client-side software in connection with the collection of the behavior and context data needed to create the models. The process is commenced in response to a triggering behavior, e.g., the subscriber making a telephone call on a wireless PDA.

Thus, in step 501, the triggering raw behavior occurs. Next, in step 503, the Behavior Listener 106 detects the trigger behavior and collects the Behavior Factors that describe that behavior. In step 505, the Behavior Listener 106 invokes the Context Service 110 to gather the most recent contextual information surrounding the detected behavior (as collected via the process illustrated in the flowchart of FIG. 4). In step 509, the Context Service 110 creates a Context object containing raw data about the Context within which the behavior occurred. The Context Service 110 returns the Context object to the Behavior Listener 108 and, in step 511, the Behavior Listener creates a Behavior-Context duple and delivers it to the Behavior Service 117.

Next, at some point in time, one or more of the stored Behavior-Context Duples are sent to the server-side software. For instance, in step 513, the Behavior Service 109 creates and sends a message containing one or more Behavior-Context Duples (termed a Behavior-Context Duple List) to the server-side portion of the invention. The process ends at step 515.

C. Processing of Behavior-Context Duples (Server-Side)

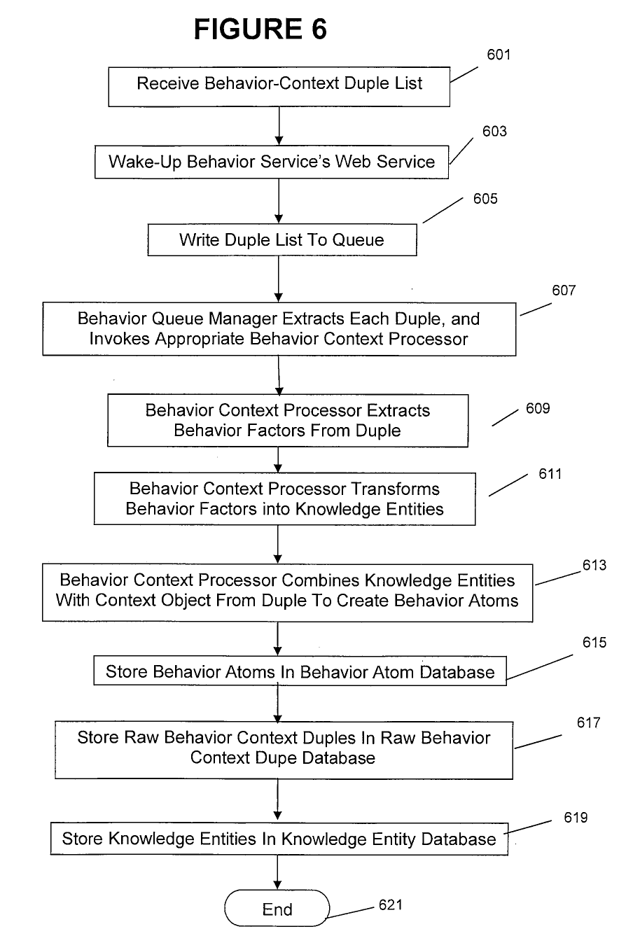

FIG. 6 illustrates process flow in connection with the handling of these Behavior-Context Duple Lists received from the client-side software in order to turn them into Behavior Atoms for storage in the Behavior Atom Database 143. This flow is invoked (step 601) when a Behavior-Context Duple List is received from the client-side software (see step 513 in FIG. 5). Upon receipt of a Behavior Context Duple List, flow proceeds to step 603 where the Behavior Web Service 131 wakes up. In step 605, the Behavior Service Web service writes the Raw Behavior-Context Duples in the received list into Queue 133. Next, in step 607, the Behavior Queue Manager 137 examines the contents of the list, extracts each Duple, and then initiates the appropriate Behavior-Context Processor 135 to use to process the duple.

In step 609, the particular processor 135 extracts the individual Behavior factors within that duple. In most cases, a single duple will be transformed into a number of Behavior factors.

Next, in step 611, each of those Behavior factors is broken down into one or more Knowledge Entities. In step 613, the Behavior Context Processor 135 pairs those knowledge entities with the context object from the duple under examination to create Behavior Atoms. In step 615, the Behavior Atoms are written to the Behavior Atom Database 143. In addition, the Behavior Context Processor 135 also stores the original Raw Behavior-Context Duples received in step 601 into the Raw Behavior Context Duple Database 139. In step 619, it also stores the extracted knowledge entities (see step 611 into the knowledge entity database 141. The process ends at step 621.

D. Additional Collection of Contextual Information (Client-Side)

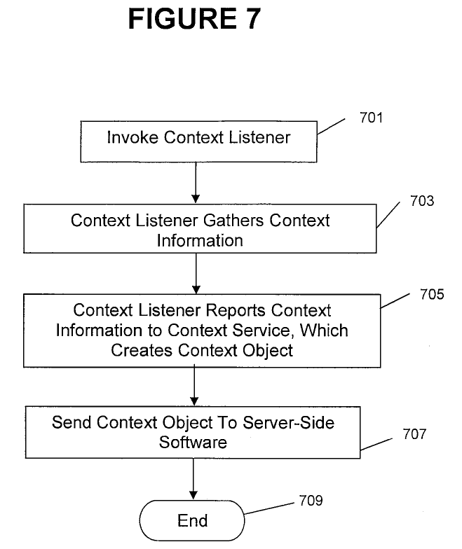

As previously noted, it also may be desirable to collect contextual information independent of the process illustrated in the flow diagram of FIG. 5, in which such collection is triggered by the occurrence of a Raw Behavior. Collection of contextual information independent of a triggering behavior would permit modeling the absence of a behavior in a certain context, which could be equally useful for purposes of customizing subscriber devices as the behavioral information. Thus, FIG. 7 illustrates a second process of the client-side software for collecting contextual information separate from the process shown in the flow diagram of FIG. 5 (which relates to collection of contextual information in response to the detection of a Raw Behavior).

In step 701, the Context Service 110 invokes the Context Listener 107 to collect contextual information. In step 703, the Context Listener 107 senses context factors to determine what contextual data it should collect and then collects it. In step 705, the Context Listener reports the collected data to the Context Service, which then creates a Context object. In step 707, the Context Service sends the Context object to the server-side software. The process ends at step 709.

E. Processing of Context Objects (Server-Side)

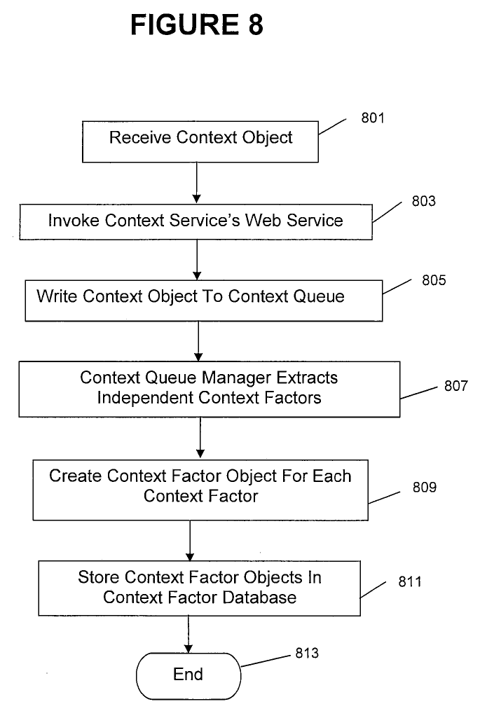

FIG. 8 illustrates server-side operation in response to receiving a Context Object from the client-side software (such as sent in step 413 of the process illustrated in FIG. 4). In step 801, the Context Object is received from the client-side software. In step 803, the Web Service 171 in the Context Service 122 is invoked to handle the Context Object. In step 805, the Context Service's Web Service 171 writes the Context Object into the Context Queue 173. In step 807, the Context Queue Manager 175 acquires the Context Object from the Queue 173 and “unrolls” it, extracting the independent Context Factors. In step 809, The Queue Manager 175 creates a separate Recorded Context Factor Object for each Context Factor utilizing the timestamp within the Context Object as a key.

In step 811, the Context Queue Manager 175 writes the Recorded Context Factor Objects into the Record Context Factor Database 179. The process ends at step 813.

F. Creating A Behavior Model (Server-Side)

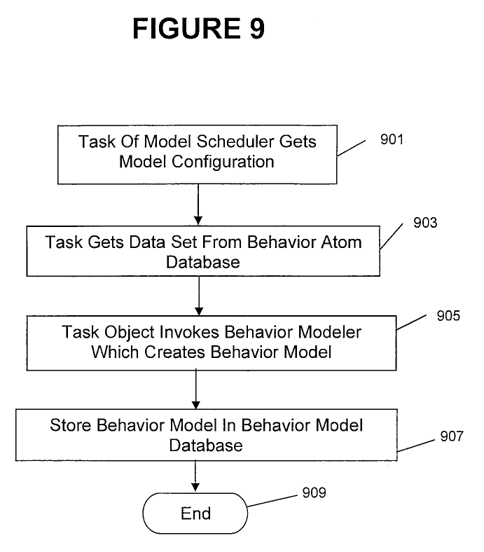

FIG. 9 illustrates process flow in connection with the Modeler Service 118 for creating a Behavior Model. This is the process of creating a Behavior Model from the collected behavior and contextual information and through which an Inference Query can be run in order to obtain a reply, e.g., a set of one or more user preferences (as a function of the particular Lever) based on context. In step 901, the Scheduler 151 of Model Service 118 invokes a Task 157 that in turn consults the Model Configuration Database 153 to retrieve the specific Model Configuration 155 to be used to create a Behavior Model. Next, in step 903, the Task 157 retrieves the appropriate dataset from the Behavior Atom database 143 and passes the dataset to the Behavior Modeler 119. In step 905, the Behavior Modeler 119 creates a Behavior Model. In step 907, the Task 157 causes the above-created Behavior Model to be stored in the Behavior Model Data Store 120. The process ends at step 909.

G. Formulation of an Inference Query (Client-Side)

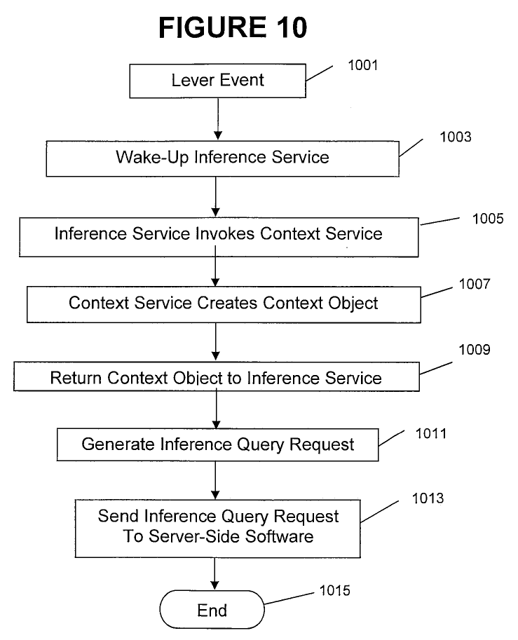

FIG. 10 illustrates process flow of the client-side software in accordance with one exemplary embodiment for the creation and transmission of an Inference Query to the server-side software. In step 1001, an event occurs either automatically or by some action of the user, that invokes the relevant Lever 108. For instance, if the Lever is the idle screen painter of a wireless PDA, the Lever may be the pressing of a button by the user to wake up the PDA from sleep mode so that there is a need to paint the device's display screen with an idle screen image. In step 1003, the Lever 108 calls the Inference Service 111. In step 1005, the Inference Service 111 invokes the Context Service 110. In step 1007, the Context Service 110 creates a Context object (as previously described above in connection with FIG. 4). In step 1009, the Context Service 110 returns the Context object to the Inference Service 111. In step 1011, the Inference Service 111 combines the Context object with the Lever information to create an Inference Query. In step 1013, the Interface Service 111 sends the Inference Query to the server-side software. The process ends at step 1015.

H. Generation of an Inference Query Reply (Server-Side)

FIG. 10 illustrates process flow on the server-side in response to receipt of an Inference Query from the client-side software (i.e., step 1013 in FIG. 10). In step 1101, the server-side software receives an Inference Query from client-side software. In step 1103, the Web Service 161 of the Inference Service 121 is woken up. In step 1105, the Web Service 161 writes the Inference Query to the Inference Service Queue 163.

Next, in step 1107, the Query Thread 165 is called and it uses the name of the model within the Inference Query to look up the appropriate Model Configuration. In step 1109, the Inference Service 121 uses the configuration as a guide to create a new Datapoint with an empty Behavior Entity. In step 1111, the Query Thread 165 first checks the Inference Service Queue 163 to determine if it has recently serviced the same Inference Query from the same device. If it has, flow proceeds to step 1113 where the corresponding Inference Query Reply is retrieved from the Inference Query Cache 167. Flow then proceed to step 1115, wherein an Inference Query Reply is returned to the requesting client-side software. The process ends at step 1117.

If, on the other hand, the Inference Query is not found in the Inference Query Cache 167, flow instead proceeds from step 1111 to step 1119. In step 1119, the Inference Service goes to the Behavior Model Data Store 120 using the aforementioned model name and Behavior Entity name to retrieve the appropriate model for this particular Inference Query. Next, in step 1121, the Inference Service 121 invokes the model and runs the DataPoint with the Empty Behavior Entity through the model to obtain an answer to the Inference Query. Next, in step 1123, the Inference Service 121 creates an Inference Query Reply.

Flow then proceeds to step 1115 to return the Inference Query Reply to the requesting client-side software. The process ends at step 1117.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method of modifying the behavior of a device as a function of context of the device based on observations of the behavior of at least a user of the device as a function of context comprising:
tracking contextual information related to the device;
tracking behavioral information of a user of the device related to the device;
correlating the behavioral information with the contextual information to determine the context within which user behaviors related to the device are exhibited;
generating a predictive model of future behavior of a user of the device as a function of context related to the device based on the tracked contextual information and the tracked behavioral information; and
adjusting operation of the device as a function of a set of contextual information related to the device based on the predictive model.

2. The method of claim 1 wherein:
the tracking of contextual information comprises collecting instances of contextual information upon the occurrence of predetermined trigger events;
the tracking of behavioral information comprises collecting instances of user interaction with the device; and
the correlating comprises, for an instance of behavioral information, retrieving the most recent instance of contextual information preceding the collection of the instance of behavioral information.

3. The method of claim 1 wherein:
the tracking of behavioral information comprises detecting instances of user interaction with the device and storing an instance of behavioral information about the user interaction; and
the tracking of contextual information comprises collecting instances of contextual information responsive to the detection of instances of user interaction with the device.

4. The method of claim 2 wherein the method is performed in a network environment and wherein the device is a node on a network and further wherein the tracking of contextual information and the tracking of behavioral information is performed at the device and the generating is performed at a separate, server node of the network, further comprising;
transmitting the contextual information and the behavioral information via the network to the server node; and
wherein the adjusting comprises:
applying a set of data comprising an instance of contextual information about the device to the predictive model;
determining from the predictive model a predicted behavior of the user as a function of the set of data comprising an instance of contextual information; and
adjusting an operational parameter of the device based on the predicted behavior.

5. The method of claim 4 wherein the operational parameter of the device comprises a configuration of a display of an idle screen of the device.

6. The method of claim 4 wherein the predictive model is generated as a function of behavioral information and corresponding contextual information of other users of other devices on the network.

7. The method of claim 6 wherein the tracked behavioral information further comprises the absence of a behavior in a particular context.

8. The method of claim 4 wherein the device comprises a plurality of devices and wherein the adjusting may comprise adjusting operation of a first device based on information collected about a second device.

9. The method of claim 4 further comprising:
providing a plurality of modeling algorithms for generating the predictive model; and
selecting a one of the modeling algorithms as a function of the set of data comprising an instance of contextual information about the device.

10. The method of claim 4 further comprising:
providing a plurality of modeling algorithms for generating the predictive model; and
wherein the adjusting comprises;
applying a set of data comprising an instance of contextual information about the device to at least two of the plurality of predictive models;
determining from each of the at least two predictive models a predicted behavior of the user as a function of the set of data comprising an instance of contextual information;
selecting a one of the at least two models that provided a better predicted behavior; and
adjusting an operational parameter of the device based on the selected predicted behavior.

11. A method of modifying the behavior of a device as a function of context of the device based on observations of the behavior of at least a user of the device as a function of context comprising:
tracking contextual information related to the device;
tracking behavioral information of a user of the device related to the device;
generating and storing behavior atoms, the behavior atoms comprising a knowledge entity combined with the instance of contextual information to which it corresponds;
generating a predictive model of future behavior of a user of the device as a function of context related to the device by applying a modeling algorithm to the behavior atoms to create a model comprising an organized set of data points;
generating an empty data point, the empty data point comprising a set of contextual information without behavioral information;
generating a predicted behavior of a user of the device by applying the empty data point to the model; and
adjusting operation of the device as a function of the predicted behavior.

12. The method of claim 11 wherein the generating a predicted behavior is performed responsive to a trigger event further comprising:
detecting the trigger event; and
generating an inference query in response to the trigger event, the inference query comprising an instance of contextual information and at least one behavior type to be predicted;
wherein the generating of the predicted behavior of the behavior type identified in the inference query is performed responsive to the inference query.

13. The method of claim 12 further comprising:
maintaining a store of inference queries and responses thereto;
prior to generating the predicted behavior responsive to an inference query, checking the store of inference queries and replies thereto to determine if a similar inference query has been serviced previously; and
if a similar inference query has been previously serviced, using the corresponding inference query reply.

14. The method of claim 12 wherein the inference query further comprises an identity of a predictive model to use to generate a reply to the inference query and wherein the predictive model identified in the inference query is used to generate the inference query reply.

15. A method of modifying the behavior of a device as a function of context of the device based on observations of the behavior of at least a user of the device as a function of context comprising:
collecting behavioral information comprising a plurality of instances of use of the device;
collecting contextual information comprising a plurality of instances of context of the device, each instance of context corresponding to one of the instances of use of the device and hereinafter termed a context object;
generating behavior-context duples comprising the instances of use of the device with the corresponding context object;
extracting from each behavior-context duple a behavior factor;
transforming each behavior factor into at least one knowledge entity;
combining each knowledge entity with the context object of the behavior-context duple from which the knowledge entity was derived, the combination hereinafter termed a behavior atom;
creating a predictive model of use behavior with respect to the device from the behavior atoms, the predictive model comprising a plurality of data points derived from the behavior atoms;
generating an inference query comprising a context object;
generating an empty data point comprising the context object from the inference query;
applying the empty data point to the predictive model to generate an inference query reply comprising a predicted behavior of a user of the device as a function of the context object; and
modifying an operation of the device as a function of the inference query reply.

16. The method of claim 15 further comprising:
storing the inference queries and corresponding inference query replies;
responsive to generation of an inference query, determining if an inference query reply to a similar inference query has previously been stored; and
if a similar inference query has previously been stored, using the inference query reply corresponding to the previously stored inference query to generate an inference query reply to the instant inference query.

17. The method of claim 15 further comprising:
collecting context objects irrespective of an accompanying use of the device for purposes of tracking the absence of behaviors with respect to the device as a function of context, hereinafter termed empty context objects; and
processing the empty context objects similarly to the behavior-context duples to create additional data points for the model.

18. The method of claim 15 wherein the inference query providing a plurality of predictive models at the server; and
selecting a one of the predictive models as a function of the corresponding inference query.

19. The method of claim 18 wherein the inference query further comprises an identity of a one of the predictive models to use in connection with that inference query.

20. The method of claim 15 wherein the device comprises a plurality of devices and wherein the modifying comprises modifying operation of a first device based on information collected about a second device.

21. A method of predicting a context within which a voluntary behavior will be exhibited based on observations of the behavior of at least a user of a device as a function of context comprising:
tracking contextual information related to the device;
tracking behavioral information of a user of the device related to the device;
correlating the behavioral information with the contextual information to determine the context within which user behaviors related to the device are exhibited;
generating a predictive model of future behavior of a user of the device as a function of context related to the device based on the tracked contextual information and the tracked behavioral information; and
predicting a context of a user of the device as a function of a behavior related to the device based on the predictive model.

22. The method of claim 21 wherein:
the tracking of contextual information comprises collecting instances of contextual information;
the tracking of behavioral information comprises collecting instances of user interaction with the device;
the correlating comprises, for an instance of behavioral information, retrieving a temporally corresponding instance of contextual information; and
wherein the predicting comprises:
applying to the predictive model a set of data comprising an instance of behavioral information related to the device; and
determining from the predictive model a predicted set of contextual information of the device as a function of the set of data comprising an instance of behavioral information.
